(19) United States
(12) Patent Application Publication
(10) Pub. No.: US 2024/0087156 A1
(43) Pub. Date: Mar. 14, 2024

(54) INFORMATION PROCESSING SYSTEM, INFORMATION PROCESSING DEVICE, CONTROL METHOD OF INFORMATION PROCESSING DEVICE, AND PROGRAM

(71) Applicant: Sony Interactive Entertainment Inc., Tokyo (JP)

(72) Inventors: Hideki Mori, Tokyo (JP); Masaomi Nishidate, Tokyo (JP); Atsushi Watanabe, Tokyo (JP)

(73) Assignee: Sony Interactive Entertainment Inc., Tokyo (JP)

(21) Appl. No.: 18/261,726

(22) PCT Filed: Feb. 4, 2021
(86) PCT No.: PCT/JP2021/004174

§ 371 Date: Jul. 17, 2023

(51) Int. Cl. G06T 7/70

(52) U.S. Cl. CPC G06T 7/70

(57) ABSTRACT

An information processing device connected to a display device and to a sensor which detects relative positions of a user and the display device is provided. This information processing device acquires information indicating the relative positions of the user and the display device and detected by the sensor, and controls a position or a posture of at least one virtual object as a control target within data of a video on the basis of the acquired information indicating the relative positions of the user and the display device. Thereafter, the information processing device outputs the data of the video generated on the basis of information associated with a virtual space where the virtual object is arranged to the display device, and causes the display device to display the data.

### TECHNICAL FIELD

The present invention relates to an information processing system, an information processing device, a control method of an information processing device, and a program.

### BACKGROUND ART

With recent diversification and performance improvement of display devices, various types of display devices have been provided, such as a display device which enlarges a viewing angle so as to allow visual recognition of display contents not only in a front direction of the display device but also in a direction relatively close to a side of the display device, and a display device allowing stereoscopic vision where different display contents are viewable according to a viewing direction.

### [SUMMARY] [TECHNICAL PROBLEM]

However, while a visual experience to be enjoyed by a user can be produced by displaying an object, such as a game character, on the above types of display devices, no consideration has been given to entertainment produced by movement of the user relative to the object visually recognized.

The present invention has been developed in consideration of the aforementioned circumstances. One of objects of the present invention is to provide an information processing system, an information processing device, a control method of an information processing device, and a program each capable of improving entertainment by controlling a displayed object according to a relative position of a user with respect to a display device.

### Solution to Problem

One aspect of the present invention for solving the aforementioned problems of the conventional example has an information processing device connected to a display device and to a sensor which detects relative positions of a user and the display device. This information processing device includes means which acquires information indicating the relative positions of the user and the display device and detected by the sensor, and generation means which generates data of a video including at least one virtual object, and controls a position or a posture of the at least one virtual object as a control target within the data of the video on the basis of the acquired information indicating the relative positions of the user and the display device. The information processing device outputs the generated data of the video to the display device and causes the display device to display the data.

### Advantageous Effects of Invention

According to this aspect of the present invention, a displayed object is controllable according to a relative position of the user with respect to the display device to improve entertainment.

### BRIEF DESCRIPTION OF DRAWINGS

FIG. 1 is a schematic block diagram depicting a configuration example of an information processing system according to an embodiment of the present invention.

FIG. 2 is an explanatory diagram depicting an example of a coordinate system set by an information processing device according to the embodiment of the present invention.

FIG. 3 is a functional block diagram depicting an example of a functional configuration of the information processing device according to the embodiment of the present invention.

FIG. 4 is an explanatory diagram depicting an example of a layout of respective devices of the information processing system according to the embodiment of the present invention.

### DESCRIPTION OF EMBODIMENT

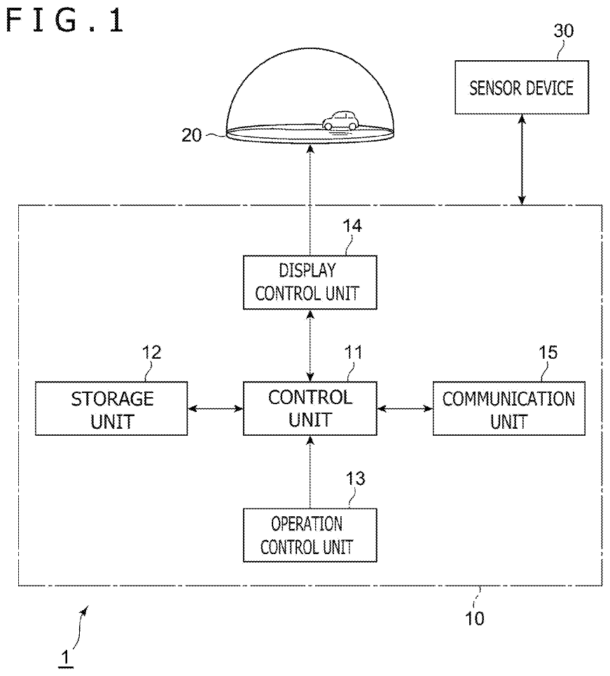

An embodiment according to the present invention will be described with reference to the drawings. As depicted in FIG. 1 by way of example, an information processing system 1 according to the embodiment of the present invention includes an information processing device 10, and a display device 20 and a sensor device 30 each connected to the information processing device 10. In addition, the information processing device 10 includes a control unit 11, a storage unit 12, an operation control unit 13, a display control unit 14, and a communication unit 15.

According to the present embodiment, the display device 20 may be an ordinary liquid crystal display or the like, or a three-dimensional display manufactured by Voxon Photonics for dynamically displaying a three-dimensional image in a space, for example.

The sensor device 30 detects a position of a user present around the display device 20, and generates information indicating relative positions of the display device 20 and the user. By way of example, the sensor device 30 detects the user around the display device 20 by a predetermined method. For example, this detection method may be either a method which uses image data captured by a camera which has an angle of view covering a movable range of the user around the display device 20, or a method which uses infrared light or the like.

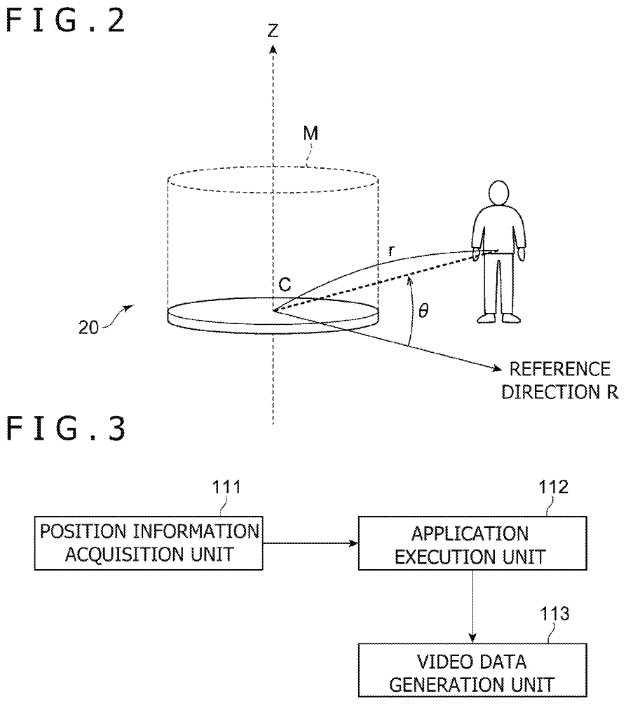

Moreover, as depicted in FIG. 2 by way of example, the sensor device 30 generates information indicating the relative position of the detected user with respect to the position of the display device 20 (hereinafter referred to as relative position information) by using a predetermined global coordinate system which has an origin located at an arrangement position of the display device 20, such as a center C of the display device 20 (a center of a virtual cuboid circumscribing an image space M displayed by the display device 20). Note that the image space M is a space where three-dimensional display is given if the display device 20 is a three-dimensional display for displaying a three-dimensional image. If the display device 20 is a display for displaying a planar image, the image space M is a plane of this image.

It is assumed as one example that a following cylindrical coordinate system is adopted for this global coordinate system to express the relative position information associated with the user, for example. Specifically, it is assumed that r in this cylindrical coordinate system (r, θ, z) is a distance from the center C of the display device 20 to a position of a target (e.g., the center of the head of the user, the same applies hereinafter) in a horizontal plane (plane parallel with a floor surface where the user stands). Moreover, it is assumed that a predetermined direction R in this horizontal plane is a reference direction, and that an angle (assumed to be a clockwise angle in a planar view) formed by a line segment extended in the reference direction from the center C of the display device 20 and a line segment extended in a direction toward the target from the center C of the display device 20 is 0 in the planar view. It is further assumed that a distance from a plane containing the center C of the display device 20 and parallel with the horizontal plane to the position of the target is z which has a positive value on the vertically upper side of the horizontal plane.

In this case, the sensor device 30 generates and outputs relative position information associated with the detected user as a position (r, θ, z) within the global coordinate system in the cylindrical coordinate system.

Moreover, the sensor device 30 may generate and output information indicating a posture of the user, instead of the relative position information associated with the detected user or together with this relative position information. For example, the information indicating the posture herein may be either information indicating which direction the user faces (front direction) (for example, an angle with respect to the reference direction within the global coordinate system described above may be available), or information indicating a pose of the user. For example, the pose information herein may be expressed by using information indicating respective positions of nodes of a bone model as positions obtained when respective portions of the body of the user, such as hands and legs, are applied to the bone model.

The control unit 11 of the information processing device 10 is a program control device such as a central processing unit (CPU), and operates according to a program stored in the storage unit 12. According to one example of the present embodiment, the control unit 11 acquires information indicating the relative positions of the user and the display device 20 and detected by the sensor device 30. Moreover, the control unit 11 manages information associated with a virtual space containing at least one virtual object. In addition, the control unit 11 generates video data representing the virtual object within the virtual space, and outputs the video data to the display device 20 to display the video data on the display device 20.

According to the present embodiment, the control unit 11 designates the at least one of the above virtual objects as a control target, and controls a position or a posture of the virtual object as the control target within the above video data, on the basis of information (relative position information) indicating the relative positions of the user and the display device 20 and acquired from the sensor device 30, to generate the video data. Details of this operation performed by the control unit 11 will be described below.

The storage unit 12 is a memory device or the like, and retains a program executed by the control unit 11. This program may be a program stored in a computer-readable and non-transitory recording medium and provided in this form, and may be stored in the storage unit 12. Moreover, the storage unit 12 also operates as a work memory for the control unit 11.

The operation control unit 13 accepts an operation from the user, and outputs the operation to the control unit 11. According to a certain example of the present embodiment, the operation control unit 13 accepts, from a controller (not depicted) carried by the user, information indicating contents of an operation performed by the user for this controller, and outputs the accepted information to the control unit 11.

The display control unit 14 outputs video information to the display device 20 according to an instruction input from the control unit 11. The communication unit 15 includes an interface such as a universal serial bus (USB) to accept information output from the sensor device 30 and output the accepted information to the control unit 11. The communication unit 15 further includes a network interface to transmit data to another information processing device 10, an external server device, or the like by using communication means such as a network according to an instruction input from the control unit 11. Furthermore, the communication unit 15 outputs, to the control unit 11, the data received via this network interface from the other information processing device 10, the external server device, or the like by using the communication means such as the network.

An example of the operation performed by the control unit 11 according to the present embodiment will be subsequently described. As depicted in FIG. 3 by way of example, the control unit 11 according to the present embodiment includes functions of a position information acquisition unit 111, an application execution unit 112, and a video data generation unit 113.

The position information acquisition unit 111 acquires relative position information output from the sensor device 30 and associated with the user, for example.

The application execution unit 112 executes a process for arranging virtual objects within a virtual space (a virtual space such as a game space) according to an application program such as a game application. It is assumed as one example that this virtual space is a space expressed by an x-y-z rectangular coordinate system having an origin located at a predetermined point and that a horizontal plane of the virtual space is defined by an x-y plane.

According to an example of the present embodiment, the application execution unit 112 arranges a virtual object which represents a ground surface having ups and downs from the horizontal surface, and a virtual object representing a road formed on this ground surface, within a virtual three-dimensional space, according to an instruction from an application program of a game using a vehicle. Moreover, the application execution unit 112 arranges a virtual object representing a vehicle on the virtual object of the ground surface (on the virtual object of the road particularly in an initial stage) on the basis of information acquired by the position information acquisition unit 111 and sets a direction, a moving speed within the virtual space, and the like associated with the object of the vehicle.

For example, the application execution unit 112 arranges the virtual object of the vehicle such that a longitudinal direction of the virtual object of the vehicle is parallel with a line segment connecting the center of the display device 20 and the position of the user, and that the user is located behind the virtual object of the vehicle (in a backing direction of the vehicle) on the basis of the relative position information (r, θ, z) associated with the user and acquired by the position information acquisition unit 111.

In this example, the application execution unit 112 defines a point Q′ included in the virtual space and corresponding to a position of a predetermined point Q included in a real space and within an image displayed by the display device 20. Moreover, the application execution unit 112 assumes that the horizontal plane in the real space and the x-y plane within the virtual space are parallel with each other, and specifies a direction in this horizontal plane with respect to the reference direction in the real space. Thereafter, the application execution unit 112 arranges the vehicle as the virtual object such that the center of the vehicle is aligned with Q′ in the virtual space. At this time, the application execution unit 112 arranges the vehicle such that a traveling direction of the vehicle is aligned with a direction shifted from the reference direction by (θ+180 degrees).

Further, the application execution unit 112 repeatedly shifts the position of the point Q′ within the virtual space from the reference direction to the direction (θ+180 degrees) corresponding to the traveling direction of the vehicle in the virtual space by a predetermined distance Δd for each predetermined timing. Thereafter, the application execution unit 112 repeatedly gives, for each predetermined timing, the video data generation unit 113 an instruction to render the virtual object within a partial virtual space (referred to as “rendering target space”) in a predetermined range defined such that the point Q′ is aligned with the position of the point Q within the image.

In addition, if the display device 20 is a three-dimensional display, the application execution unit 112 at this time defines the rendering target space such that the horizontal plane in the real space in the image displayed by the display device 20 is parallel with the x-y plane within the virtual space.

The video data generation unit 113 having received the instruction of rendering from the application execution unit 112 generates, as video information displayable by the display device 20, a video of the virtual object included in the rendering target space and corresponding to the instruction.

For example, if the connected display device 20 is a three-dimensional display, the video data generation unit 113 generates video data where voxels corresponding to a target of display are arranged on the basis of the virtual object included in the rendering target space and corresponding to the instruction from the application execution unit 112.

Moreover, if the connected display device 20 is an ordinary liquid crystal display or the like, the video data generation unit 113 generates two-dimensional video data, which is data obtained when the rendering target space is viewed in a direction toward the point Q′ from a predetermined direction (e.g., a Z-axis direction in the virtual space), on the basis of the virtual object included in the rendering target space and corresponding to the instruction from the application execution unit 112.

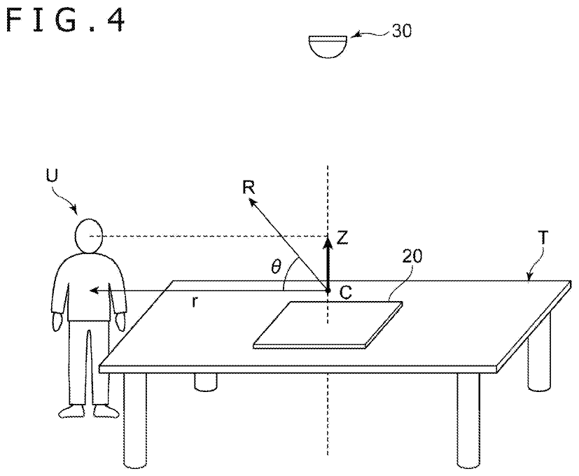

As described above, various types of processes corresponding to the types of the display device 20 are widely known as the process for generating data of a video displayed on the display device 20 on the basis of data of the virtual object set within the virtual space. Accordingly, detailed explanation about this process is not presented herein.

[Operation] The present embodiment basically has the configuration described above, and operates in a manner of a following example. In addition, it is assumed that the display device 20 in the following example is a three-dimensional display which displays a three-dimensional image by voxels, and is disposed on a table T or the like as depicted in FIG. 4 by way of example. It is assumed that the user (U in FIG. 4) is movable to any position around the table T where the display device 20 is disposed, and that the display device 20 is capable of presenting a video viewed from any position of the user standing around the table T.

Further, according to this example, the sensor device 30 has a camera installed on a ceiling inside a room where the table T is disposed, for example, and is configured to detect a position of the display device 20 and a position of the user, and generate and output information indicating a relative position of the user with respect to the display device 20 by using the cylindrical coordinate system depicted in FIG. 2 by way of example.

In addition, the information processing device 10 connected to the display device 20 arranges virtual objects of a ground surface having ups and downs, and a road formed on this ground surface within a virtual three-dimensional space, and arranges a virtual object representing a vehicle on the virtual object of the road according to an instruction from the game application. Thereafter, the information processing device 10 in this example controls a traveling direction of the virtual object of the vehicle on the basis of relative position information associated with the user with respect to the display device 20.

Specifically, when the virtual space where the virtual objects are disposed is expressed by an (x, y, z) rectangular coordinate system, the information processing device 10 arranges, within this coordinate system, the virtual object of the ground surface having ups and downs from an x-y plane of the coordinate system. Moreover, the information processing device 10 arranges the virtual object representing the road on the virtual object of this ground surface. In the following example, it is assumed that each of the virtual objects of the ground surface and the road has a sufficient size and a sufficient length for expressing a state of traveling of the vehicle in comparison with the size of the vehicle (i.e., each of these virtual objects is sufficiently larger or sufficiently longer than the virtual object of the vehicle).

Further, the information processing device 10 initially defines the point Q′ on this road as a point included in the virtual space and corresponding to a position of the predetermined point Q included in the real space and within an image displayed by the display device 20. Note that the information processing device 10 at this time sets the virtual space such that the horizontal plane in the real space and the x-y plane within the virtual space are parallel with each other.

Thereafter, the information processing device 10 arranges the vehicle as the virtual object such that the center of the vehicle is aligned with Q′ within the virtual space. At this time, the information processing device 10 acquires relative position information (r, θ, z) associated with the user from the sensor device 30, and arranges the vehicle such that the traveling direction is aligned with a direction shifted from the reference direction by (θ+180 degrees).

With a start of the game in a following stage, the information processing device 10 subsequently repeats acquisition of the relative position information (r, θ, z) associated with the user from the sensor device 30 for each predetermined timing. Thereafter, when acquiring this relative position information (r, θ, z), the information processing device 10 performs a rendering process for generating video data displayable by the display device 20 and indicating the virtual object in the virtual space and within a predetermined rendering target space defined such that the point Q′ is aligned with the position of the point Q within the above image while shifting the position of the point Q′ within the virtual space to a point located on the virtual object of the ground surface in the vertical direction from a position shifted in a direction of (θ+180 degrees) corresponding to the traveling direction of the vehicle from the reference direction by a predetermined distance Δd in the virtual space.

By repeated execution of this process performed by the information processing device 10, the user is allowed to control the traveling direction of the vehicle by moving in a circumferential direction (a direction for changing a value of 0 detected by the sensor device 30) around the display device 20.

According to this example of the present embodiment, entertainment associated with the objects being viewed and recognized by the user is produced by own movement of the user.

[Example additionally using distance or the like] In addition, this example of the present embodiment uses information which is included in the relative position information associated with the user and output from the sensor device 30, and indicates the angle at which the display device 20 is visually recognized. However, the information to be used in the present embodiment is not limited to this example.

For example, the information processing device 10 may define the traveling direction of the virtual vehicle described above on the basis of the direction of the angle θ indicated by the relative position information associated with the user, and define the moving speed (corresponding to the value of Δd in the above example) of the vehicle on the basis of the distance r indicated by the relative position information associated with the user.

In this case, following control is achievable, for example. The traveling speed of the vehicle increases as the user is located closer to the display device 20. The traveling speed of the vehicle decreases as the user is located farther from the display device 20.

In another example, the information processing device 10 may define the traveling speed of the virtual vehicle described above on the basis of a height z of the head of the user as a value indicated by the relative position information. In this case, such control is achievable that the traveling speed of the vehicle increases as the head of the user lowers.

[Use of controller] Note that the user is not necessarily required to perform the operation by using the controller in this example of the present embodiment.

[Control based on viewing angle of display device and detection range of sensor device] In addition, in a case where a visually recognizable range of a video on the display device 20 in the horizontal plane is not a 360-degree range but a limited range, the information processing device 10 may perform a following process so as to limit the moving range of the user to this limited range.

According to one example of the present embodiment, the information processing device 10 maps a movable range of the user on a control range of a control target (e.g., the virtual object of the vehicle in the above example) based on the relative position information associated with the user.

Specifically, it is assumed that the control target based on the relative position information associated with the user is an arrangement angle of the virtual object in the virtual space, and that a range of this arrangement angle is ±θmax degrees (defined as 360 degrees>θmax>0 degrees) with respect to the reference direction in a state where a center position of the range is located at the center C of the display device 20 within the horizontal plane.

In addition, the viewing angle of the display device 20 is adopted as the user movable range. Assuming that this viewing angle is ±(p degrees (defined as 360 degrees>φ>0 degrees) with respect to the reference direction, the information processing device 10 uses information θ (θ ≤φ is assumed herein) associated with an angle direction in the relative position information associated with the user and detected by the sensor device 30. When θmax≤φ, the information processing device 10 determines the arrangement angle of the virtual object on the basis of the value of θ itself output from the sensor device 30.

On the other hand, when θmax>φ, the information processing device 10 acquires θ′ obtained by mapping the angle range of ±y degrees on a range of ±θmax on the basis of θ′=θ×(θmax/φ), and determines the arrangement angle of the virtual object on the basis of this value of θ′.

According to this example, even in a case where the user movable range (a range where the user is allowed to visually recognize a video on the display device 20) is ±90 degrees in a situation where ±150 degrees is desired to be set as the arrangement angle of the virtual vehicle, for example, control covering the entire range of the arrangement angle is achievable if the user moves in this range.

[Control for case where multiple users are present] While the above explanation has been presented on the assumption that the single user is present around the display device 20, the present embodiment is not limited to this example. For example, in addition to the user playing the game application, another user watching the play of the playing user may be present around the display device 20.

In this example, the user playing the game is only made identifiable for the sensor device 30 by attaching markers, such as illuminants, to the user playing the game, giving each of the users a different light emission color of a light emitting diode (LED) included in the controller device carried by the corresponding user, or by other methods.

According to yet another example, the sensor device 30 may acquire relative position information for each of a plurality of users present around the display device 20. In this example, the sensor device 30 allocates unique identification information to each of the users beforehand. Thereafter, the sensor device 30 detects the relative position information for each of the users, and outputs, to the information processing device 10, the detected relative position information and the identification information unique to the corresponding user in association with each other.

Note that identification for each of the users may be achieved by giving each of the users a different light emission color of the LED included in the controller device carried by the corresponding user as described above. Needless to say, this method is only an example, and the sensor device 30 may identify the respective users by a facial recognition process or the like, for example.

When the number of users associated with a process performed by the information processing device 10, such as a game application, is N in this example, the display device 20 may set a movable range of each of the users for each of divisions of Y/N of a viewing angle Y of the display device 20, and display a guide of the movable range for each of the users at a start of the process of the application program or other occasions.

When N=2 users are present around the display device 20 in this configuration in a situation where a three-dimensional display or the like has φ=360 degrees, the information processing device 10 allocates a range of 180 degrees to each of the users as a movable range. In this case, the information processing device 10 allocates a range from −90 degrees to +90 degrees including 0 degrees with respect to the reference direction to one of the users, and a range from +90 degrees to 270 degrees (i.e., −90 degrees) with respect to the reference direction to the other user, and display a guide indicating these allocations.

Subsequently, after the users are positioned around the display device 20 according to this guide, the information processing device 10 may start the process of the application program, and perform control such as generation of data of a video displayed on the display device 20 on the basis of relative position information associated with each of the users.

Moreover, in a case where a plurality of users are present around the display device 20 as in this example, the information processing device 10 may control movements achieved by virtual objects for the corresponding users in a manner different for each of the users on the basis of positions and movements of the respective users according to each of the distances r to the users.

Specifically, the information processing device 10 may control a movement amount Δd of each of virtual objects corresponding to a plurality of users (e.g., game characters to be controlled by the users) on the basis of information indicating the distance r included in relative position information associated with the corresponding user such that the movement amount Δd increases in proportion to the distance r, for example, and control a moving direction of each of the virtual objects according to information associated with the angle θ included in the relative position information associated with the corresponding user.

In this case, positioning of the respective users with respect to the display device 20 is reflected in the control of the game characters of the respective users, for example. Accordingly, entertainment produced by own movements of the users around the display device 20 is allowed to further improve.

Moreover, while described herein has been the example of the control of the movement amount, the present embodiment is not limited to this example. The information processing device 10 may control an information display range within the display device 20 for each of the users according to the distance r included in the relative position information associated with the corresponding user in such a manner that the display range increases as the distance r decreases.

According to this example, supply of information is more promoted for the user located closer to the display device 20. Accordingly, the user is allowed to achieve operations such as moving closer to the display device 20 and acquiring information as necessary.

Further, the information processing device 10 may set a different parameter of a physical simulation for each of the virtual objects controlled by the respective users within the virtual space according to the distance r included in the relative position information associated with the corresponding user. For example, the information processing device 10 may control a gravity parameter (fall acceleration for the ground surface within the virtual space) acting on each of the virtual objects such that this gravity parameter increases as the distance r decreases. Similarly, in a case where each of the users uses an application program where an operation for a virtual object controlled by the user is achieved by a pose of the user, the information processing device 10 may set a control level variable according to the distance r included in the relative position information associated with the corresponding user. This example achieves such control that a change of an arrangement angle, a moving distance, or the like of the virtual object increases as a pose is made at a shorter distance from the display device 20 even in a case of the same pose performed for the operation.

[Control for case where multiple display devices are present] In still another example of the present embodiment, the information processing device 10 may transmit and receive information to and from the other information processing device 10 or the like to perform a process of an application program. For example, the information processing device 10 acquires relative position information associated with the user present around the display device 20 connected to the information processing device 10 from the sensor device 30 connected to the information processing device 10, and controls an arrangement of a virtual object to be controlled by the corresponding user within the virtual space, and also transmits the acquired relative position information associated with the user to the other information processing device 10.

Moreover, the information processing device 10 controls an arrangement of a virtual object to be controlled by a user (referred to as another user for distinction between the users), who is present around the display device 20 connected to the other information processing device 10, within the virtual space on the basis of relative position information associated with the other user and received from the other information processing device 10.

According to this example, a process of one game application or the like can be performed by a plurality of users using the display devices 20 different for each. Moreover, in this example where a plurality of the display devices 20 are present, a viewing angle or the like of each of the plurality of display devices 20 may be different from each other. In a case where the display devices 20 each having a different viewing angle are used, each of the information processing devices 10 in this example may exchange information indicating the viewing angle of the display device 20 connected to the corresponding information processing device 10 with the other information processing device or devices 10, obtain information indicating a smallest viewing angle φmin, and achieve control such that the movable range of the user falls within this smallest viewing angle.

For example, the information processing device 10 connected to the display device 20 having a larger viewing angle φ than this smallest viewing angle φmin obtains information θ′ associated with an angle after correction by multiplying by information θ associated with an angle indicated by the relative position information obtained from the sensor device 30 and associated with the user around the corresponding display device 20 by φmin/y. Thereafter, an arrangement direction or the like of the virtual object to be controlled by the user may be controlled on the basis of the information θ′ associated with the angle after correction.

[Installation environment of display device] In addition, in a certain example of the present embodiment, the information processing device 10 may not only control a position or a posture of a virtual object within the virtual space on the basis of relative position information associated with the user, but also perform a following process.

Specifically, in a certain example of the present embodiment, the sensor device 30 may acquire not only the relative position of the user, but also information indicating a position (relative position), illuminance, a color, or the like of lighting in an environment where the display device 20 is disposed, and output the acquired information to the information processing device 10.

The information processing device 10 in this example may arrange a virtual light source at a position included in the virtual space and corresponding to a light source position input from the corresponding sensor device 30, and light the virtual object. In this configuration, lighting considering the position of the light source in the real space is also applied to the virtual object within the virtual space. Accordingly, a direction and a shape of a shadow are specified in consideration of lighting in the real space, and therefore more natural display is achievable. Moreover, when illuminance or a color of the corresponding light source in the real space is detected by the sensor device 30, illuminance or a color of the virtual light source may be defined on the basis of information indicating the illuminance or the color of the light source in the real space.

Further, when the user is present between the light source detected by the sensor device 30 in the real space and the display device 20, the information processing device 10 may arrange a virtual object provided for forming a shadow of the user for each of virtual objects between a virtual light source corresponding to the above light source in the virtual object and the respective virtual objects, and produce such an effect that the shadow of the user is reflected in the virtual objects.

While information associated with the position or the like of the light source is acquired by the sensor device 30 in this example, the user may set a relative position or the like of the light source in the real space with respect to the display device 20 instead of the information acquired by the sensor device 30. In this example, the information processing device 10 sets the position or the like of the virtual light source within the virtual space on the basis of the set information. In this case, the sensor device 30 is not required to detect the position of the light source. Accordingly, a processing load can be reduced.

In a further example, the information processing device 10 may control illuminance or on/off of lighting in the real space according to a status of an effect of an application program to be executed. This process is achievable by a widely known process performed by home automation. Accordingly, detailed explanation associated with a method for this process is not presented herein.

[Process by three-dimensional pseudo-display] Note that there exists the display device 20 of such a type which requires information associated with a position of the user with respect to the display device 20 to display a three-dimensional video. In this example, the sensor device 30 may output information associated with a relative position of the detected user to not only the information processing device 10 but also the display device 20.

The display device 20 generates an image as viewed from the position of the corresponding user on the basis of video data input from the information processing device 10 with reference to the information associated with the position of the user and detected by the sensor device 30, and displays the generated image.

[Another example of posture control] In addition, according to the example described above, the information processing device 10 sets a posture (e.g., a direction) of a virtual object to be controlled by the user such that the front of this virtual object faces a direction of (θ+180 degrees) from the reference direction, for example, on the basis of the information θ associated with the angle of the position of the user with respect to the reference direction and included in the relative position information associated with the user and output from the sensor device 30. However, the present embodiment is not limited to this example.

For example, the information processing device 10 sets the front direction of the virtual object on the basis of the information θ associated with the angle of the position of the user with respect to the reference direction and included in the relative position information associated with the user and output from the sensor device 30 according to an instruction from the user while switching between:
θ;
θ+90 degrees;
θ+180 degrees; and
θ+270 degrees.

While the angle to be added is selected from 0, 90, 180, and 270 degrees herein, the front direction may be set for each smaller angle, such as 45 degrees. Alternatively, for example, a substantially continuous value, such as 1 degree, may be designated for the settings.

According to this example, an own model representing the user is designated as a virtual object (referred to as a user model object), and a front direction of this user model object is determined on the basis of the information θ associated with the angle of the position of the user with respect to the reference direction according to any one of the above settings. In addition, virtual objects representing clothes to be sold are overlapped with the user model object in such a manner that front directions of the virtual objects of the clothes are aligned with the front direction of the user model object, and are provided for a rendering process.

In this configuration, the user is allowed to view the front, the side, and the back of the user in a state where the user is virtually wearing the clothes to be sold. Moreover, when the information processing device 10 transforms the user model object into a shape of a pose of the user detected by the sensor device 30 and similarly transforms shapes of the virtual objects of the clothes (these processes are achievable by a known process using a bone model, and therefore are not explained in detail), the user is allowed to visually recognize the wearing state in a desired direction.

### REFERENCE SIGNS LIST

1: Information processing system
10: Information processing device
11: Control unit
12: Storage unit
13: Operation control unit
14: Display control unit
15: Communication unit
20: Display device
30: Sensor device
111: Position information acquisition unit
112: Application execution unit
113: Video data generation unit

1. An information processing system comprising:
a display device;
an information processing device which generates data of a video displayed by the display device; and
a sensor which detects relative positions of a user and the display device,
wherein the information processing device includes
means which acquires information indicating the relative positions of the user and the display device and detected by the sensor, and
means which generates data of a video including at least one virtual object, and controls a position or a posture of the at least one virtual object as a control target within the data of the video on a basis of the acquired information indicating the relative positions of the user and the display.

2. An information processing device connected to a display device, and to a sensor which detects relative positions of a user and the display device, the information processing device comprising:
an acquiring circuit operating to acquire information indicating the relative positions of the user and the display device and detected by the sensor; and
a generating circuit operating to generate data of a video including at least one virtual object, and controls a position or a posture of the at least one virtual object as a control target within the data of the video on a basis of the acquired information indicating the relative positions of the user and the display device,
wherein the information processing device outputs the generated data of the video to the display device, and causes the display device to display the data.

3. The information processing device according to claim 2, wherein
the sensor outputs information indicating the relative positions of the user and the display device and including angle information that indicates a direction where the user is located with respect to a reference direction that is a predetermined direction within a horizontal plane and is determined according to a relation with an arrangement position of the display device, and
the generating circuit controls a position or a posture of the virtual object as the control target within the data of the video on a basis of the information indicating the relative positions of the user and the display device and detected by the sensor.

4. The information processing device according to claim 3, wherein
the generating circuit controls the posture of the virtual object as the control target within the data of the video on a basis of the angle information determined according to the relation with the arrangement position of the display device, output from the sensor, and indicating the direction where the user is located with respect to the reference direction.

5. The information processing device according to claim 2, wherein
the sensor outputs information which indicates the relative positions and includes information indicating a distance to the position where the user is located, and determined according to a relation with the arrangement position of the display device, and
the generating circuit controls the virtual object as the control target on a basis of the information indicating the distance determined according to the relation with the arrangement position of the display device and output from the sensor.

6. An information processing method of an information processing device connected to a display device, and to a sensor which detects relative positions of a user and the display device, the information processing method comprising:
acquiring information indicating the relative positions of the user and the display device and detected by the sensor;
generating data of a video including at least one virtual object;
controlling a position or a posture of the at least one virtual object as a control target within the data of the video on a basis of the acquired information indicating the relative positions of the user and the display device; and
outputting the generated data of the video to the display device.

7. A non-transitory, computer-readable storage medium containing a computer program, which when executed by an information processing device connected to a display device and to a sensor which detects relative positions of a user and the display device, causes the information processing device to perform an information processing method by carrying out actions, comprising:
acquiring information indicating the relative positions of the user and the display device and detected by the sensor;
generating data of a video including at least one virtual object;
controlling a position or a posture of the at least one virtual object as a control target within the data of the video on a basis of the acquired information indicating the relative positions of the user and the display device; and
outputting the generated data of the video to the display device.
